(19) United States
(12) Patent Application Publication
(10) Pub. No.: US 2025/0232618 A1
(43) Pub. Date: Jul. 17, 2025

(54) SYSTEM AND METHOD FOR ACOUSTIC DETECTION OF PHASES OF A MINING-TRUCK CYCLE

(71) Applicant: COMPAGNIE GENERALE DES ETABLISSEMENTS MICHELIN, Clermont-Ferrand (FR)

(72) Inventors: ANTOINE PATURLE, Clermont-Ferrand (FR); MARCOS CONTRERAS, Clermont-Ferrand (FR)

(21) Appl. No.: 18/852,166

(22) PCT Filed: Feb. 2, 2023
(86) PCT No.: PCT/EP2023/052529

§ 371 Date: Sep. 27, 2024

(30) Foreign Application Priority Data
Mar. 29, 2022 (FR) 2202807

(51) Int. Cl. G07C 5/08; G06Q 50/02; G07C 5/00

(52) U.S. Cl. CPC G07C 5/08; G06Q 50/02; G07C 5/008

(57) ABSTRACT

A system (100) installed in a mining truck (10) implements a method for detecting acoustic events related to phases of a cycle of the mining truck, such that each acoustic event is characterized by an acoustic signature allowing periods of loading and of unloading and periods of driving loaded and empty to be identified from the amplitude and frequency of the recordings. A method (200) detects acoustic events denoting phases of a cycle of the mining truck. A mining truck has a module for executing an analyzing application for analyzing one or more signals indicative of acoustic events in order to determine whether the mining truck is in the course of a mining cycle and to determine the current phase of the mining cycle being executed by the mining truck.

### TECHNICAL FIELD

The invention is directed to a system and method for automatically processing a signal to identify acoustic events and to determine, from these acoustic events, acoustic scenes corresponding to phases of a mining cycle.

### CONTEXT

In the field of mining, typical mining operations involve loading aggregate onto a plurality of mining vehicles, particularly mining haul trucks. These haul trucks (or “mining trucks” or “trucks”) may make several trips per day between a loading site and an unloading site (for example, a processing or shipping facility). These trucks are configured to perform cyclical operations related to various industries, such as mining, forestry, waste management, construction and quarrying, transportation, logistics and agriculture. The load may include building materials and/or other materials such as sand, gravel, stones, rocks, earth, bitumen, coal, ores, and other excavation materials.

With reference to FIG. 1, a haul truck (or “truck”) 10 is shown that transports heavy loads over set routes. By way of example, the truck 10, which is used on mining sites, is a dump truck and includes a dump body 10a pivotally mounted on a frame 10b (for example, via hydraulic and/or pneumatic means). The dump body 10a could be of another known type, for example of the ejector type, of the side-dump type or of the bottom-dump type. These vehicles are used in open-cast mines having a track that allows the vehicles to descend empty and re-ascend loaded with the ore extracted from the workface and that makes up the payload. The truck 10 repeats a working cycle of this type (as used here, the term “cycle” refers to a repeated trip). In general, typical mining operations involve hundreds of trips during which each haul truck 10 must pass through various operating states, such as the loading state, transporting state, dumping state and bunching state during transport from the loading site to the dumping site. By way of example, a cycle performed by one or more trucks 10 may include, in succession, unloading the truck 10 at an unloading point; a phase of driving, unloaded, to a loading point; loading ore into the truck 10; a phase of driving, loaded, to the unloading point; and unloading the truck 10 at the unloading point (which also starts the following cycle).

In order to verify the state of advance of the work being carried out and/or the efficiency of operation of a mining vehicle, it will be understood that detection of mining cycles is a subject relevant to mining vehicle managers (including, without limitation, fleet companies to which the one or more mining vehicles belong, mining companies and mining-vehicle manufacturers). This detection is often performed using vibration-detecting technologies (for example, accelerometers positioned on the mining vehicle) that are associated with position and/or speed sensors of the mining vehicle (for example, by means of a global positioning system (GPS), an inertial navigation system and/or other equivalent locating means). By way of example, U.S. Pat. No. 9,792,739 discloses a system and method for detecting various phases of a mining cycle by combining the data of an inertial measurement unit (accelerometer and rotation) and the GPS position of a mining vehicle. Also, U.S. Pat. No. 9,302,859 discloses a system in which a speed sensor of the mining vehicle is added to increase the robustness of detection of the phases of the mining cycle. Furthermore, U.S. Pat. No. 10,308,157 discloses a monitoring system in which a single sensor, including an accelerometer positioned under the dump body of a dump truck, is employed to deduce the various phases of the mining cycle based on analysis of vertical accelerations. U.S. Pat. No. 7,395,184 discloses a method for determining mining cycles based on continuous measurement of variations in the load of a dump truck (estimated from the oil pressure in the suspensions).

Despite incorporation of these solutions in the industry, the prior art does not contain any disclosure of an acoustic means for detecting mining cycles. With an acoustic recording of driving of a mining vehicle, the key steps of mining-truck cycles could be deduced, with each step of the cycle being described as a particular acoustic “scene” or “phase”. Each acoustic scene itself includes a certain number of specific unit acoustic events, arranged in a certain chronological order. Once recorded, these events may then be detected automatically by processing the signal specific to each type of event.

The main phases of the mining cycle may be characterized by one or more acoustic events, the ensemble of which form an acoustic scene. Thus, the disclosed invention employs acoustics in relation to mining operations, where a measurement of the time spent performing certain processes (such as loading and unloading a mining vehicle) is an important piece of information that may be used to study and potentially increase the productivity and efficiency of the mining operation.

### SUMMARY OF THE INVENTION

The invention is directed to a system installed in a mining truck that includes a dump body pivotally mounted on a frame, a cab where an operator of the mining truck sits, and an engine associated with the frame, the system implementing a method for detecting acoustic events denoting phases of a cycle of the mining truck, characterized in that the system includes:
at least one acoustic device that captures an acoustic event associated with a phase of a cycle of the mining truck and that generates one or more signals indicative of the captured acoustic event, each phase having of a specific number of acoustic events arranged in a predetermined chronological order, the acoustic device including:
   at least one microphone that detects and captures the acoustic events associated with each phase of the mining cycle, the microphone being mounted on or in the mining truck; and
   an acoustic recording device associated with the microphone that records the acoustic events captured by the microphone;
at least one memory configured to store an application for analyzing the signals generated by the acoustic device and representative of the phases executed by the mining truck with which the captured acoustic events are associated;
one or more communication servers each including at least one or more processors operationally connected to the memory, the one or more processors including a module for executing the analyzing application, which processes the signals indicative of the acoustic events to determine the presence and/or absence of particular sounds and/or their frequency and duration, the one or more processors being capable of executing programmed instructions stored in memory to perform the following steps:
a step of operating the system, during which step the acoustic device captures one or more acoustic events in real time and generates one or more signals indicative of each captured acoustic event;
a step of sending the one or more captured signals to the server, which step is performed by the acoustic device;
a step of filtering and analyzing the sent signals, which step is performed by the processor of the server receiving the signals; and
a step of constructing a graph of sound cycles representing temporal correlations between the analyzed acoustic events and an expected chronological order of one or more associated phases, during which step the processor compares the constructed graph with one or more predefined graphs, each being indicative of the arranged and specific unit acoustic events and the phases with which they are associated;

such that each acoustic event is characterized by one acoustic signature allowing periods of loading and of unloading and periods of driving loaded and empty to be identified from the amplitude and frequency of the recordings.

In one embodiment of the system of the invention, the phases of the mining cycle in which the associated acoustic events are detected and recorded include:
a phase of loading ore into the dump body while the mining truck is stationary in a loading area;
a phase of driving the mining truck loaded;
a phase of unloading the ore with the mining truck 10 stationary in an unloading area,
a phase of driving the mining truck empty; and
at the end of the cycle, a phase of waiting for loading with the mining truck stationary.

In one embodiment of the system of the invention, the acoustic signature of each acoustic event is classified into two types of sounds including:
a white noise associated with at least one sound among an engine sound, a breaking sound and/or an ore sound; and
a harmonic noise associated with at least one sound among an engine speed, a horn, a reversing sound and a resonance of the dump body.

In one embodiment of the system of the invention, the acoustic recording device includes acceleration-detecting means mounted on or in the mining truck so as to be able to detect the shock of loading and/or unloading the truck.

In one embodiment of the system of the invention, the system further includes at least one telematics system allowing operational data of the mining truck to be monitored and recorded.

In one embodiment of the system of the invention, the system further includes locating means mounted on or in the mining truck selected from a global positioning system and an inertial navigation system.

In one embodiment of the system of the invention, the system further includes a communication network that manages the data fed to the system, the communication network incorporating at least one communication server with at least one processor that manages the data corresponding to an identified mining truck.

In one embodiment of the system of the invention, the server is associated with one or more mining-truck managers, including one or more mining companies to which the mining truck belongs.

The invention is also directed to a method for detecting acoustic events associated with phases of a cycle of a mining truck, the method being implemented by a system installed in a mining truck, characterized in that the method includes the following steps:
a step of operating the system, during which step an acoustic device of the system captures one or more acoustic events in real time and generates one or more signals indicative of each captured acoustic event;
a step of sending the one or more captured signals to a server of the system, which is step is performed by the acoustic device;
a step of filtering and analyzing the sent signals to determine the presence and/or absence of particular sounds and/or their frequency and duration, this step being performed by a processor of the server receiving the signals; and
a step of constructing a graph of sound cycles representing temporal correlations between the analyzed acoustic events and an expected chronological order of one or more associated phases, during which step the processor may compare the constructed graph with one or more predefined graphs, each being indicative of the arranged and specific acoustic events and the phases with which they are associated;

such that each acoustic event is characterized by an acoustic signature allowing periods of loading and of unloading and periods of driving loaded and empty to be identified from the amplitude and frequency of the recordings.

In one embodiment of the method of the invention, the method further includes a method for processing a wideband white-noise acoustic signal associated with at least one sound among an engine sound, a breaking sound and/or an ore sound, this step including the following steps:
a step of filtering the signal in the corresponding frequency band;
a decimating step, in order to limit computational load;
a step of computing a root-mean-square sound level of the filtered signal; and
a step of comparing the computed root-mean-square sound level with a predetermined threshold.

In one embodiment of the method of the invention, the method further includes a step of processing a wideband white-noise acoustic signal associated with at least one sound among an engine sound, a breaking sound and/or an ore sound, this step including the following steps:
a step of computing the frequency spectrum in a sliding window of the time-domain signal; and
a step of deducing acoustic power via integration in the desired frequency band.

In one embodiment of the method of the invention, the method further includes a step of processing a harmonic acoustic signal associated with at least one sound among an engine speed, a horn, a reversing sound and a resonance of the dump body, this step including the following steps:
a step of filtering the signal in the corresponding frequency band;
a step of decimating the raw signal; and
a step of detecting the harmonics of the resulting signal.

In one embodiment of the method of the invention, the step of detecting the harmonics of the signal is performed by way of a method selected from comb-filtering, cepstral-analysis, spectral-autocorrelation, and synchronous-averaging methods.

In one embodiment of the method of the invention, the method further includes a step of identifying expected locations of the mining truck, wherein the identifying step includes identifying coordinates of each expected location using data obtained by a locating means mounted on or in the mining truck.

The invention also relates to a mining truck, including a dump body pivotally mounted on a frame, a cab in which an operator of the mining truck sits, and an engine associated with the frame, characterized in that the mining truck has a module for executing a method for detecting acoustic events denoting phases of a cycle of the mining truck, the executing module including an analyzing application for analyzing one or more signals indicative of the acoustic events in order to determine whether the mining truck is in the course of a mining cycle and, when an acoustic event represented by these signals is present, to determine the current phase of the mining cycle being executed by the mining truck.

Other aspects of the invention will become apparent from the following detailed description.

### BRIEF DESCRIPTION OF THE DRAWINGS

The nature and various advantages of the invention will become more evident on reading the following detailed description, in conjunction with the attached drawings, in which the same reference numerals designate identical parts throughout, and in which:

FIG. 1 shows a perspective view of an embodiment of a mining truck having the system of the invention installed.

FIG. 2 shows an example of a set of phases of a mining cycle performed by the mining truck of FIG. 1.

FIGS. 3 and 4 show examples of acoustic scenes defined via a time-frequency analysis of an acoustic signal recorded during a mining cycle executed by the mining truck of FIG. 1 and while the mining truck is stationary.

FIG. 5 shows a typical line spectrum of a harmonic acoustic signal of an engine of the mining truck while stationary.

FIG. 6 shows a typical line spectrum of a harmonic acoustic signal of the engine brake of the mining truck.

FIG. 7 shows an example of an acoustic scene defined via a time-frequency analysis of an acoustic signal recorded during a loading phase of the mining truck.

FIG. 8 shows a typical line spectrum of a harmonic signal of the sound of loading during a loading phase of the mining truck.

FIG. 9 shows a typical line spectrum of a harmonic signal of the sound of the engine of the mining truck during a phase of driving uphill.

FIG. 10 shows an example of an acoustic scene defined via a time-frequency analysis of an acoustic signal recorded during an unloading phase of the mining truck.

FIG. 11 shows acoustic phases of a mining cycle executed by the mining truck of FIG. 1.

FIG. 12 shows a flowchart of an embodiment of a method of the invention for detecting acoustic events associated with the phases of a mining truck cycle.

FIG. 13 shows an example of a variation as a function of time in the raw acoustic parameter of a number of acoustic events detected during a mining cycle.

FIG. 14 shows an example of sound mining cycles detected during part of the mining cycle.

FIGS. 15 and 16 show, respectively, examples of acoustic scenes during loading and unloading of the mining truck of FIG. 1.

FIG. 17 shows an example of a graph of an acoustic timeline of acoustic events recorded during a mining cycle.

### DETAILED DESCRIPTION

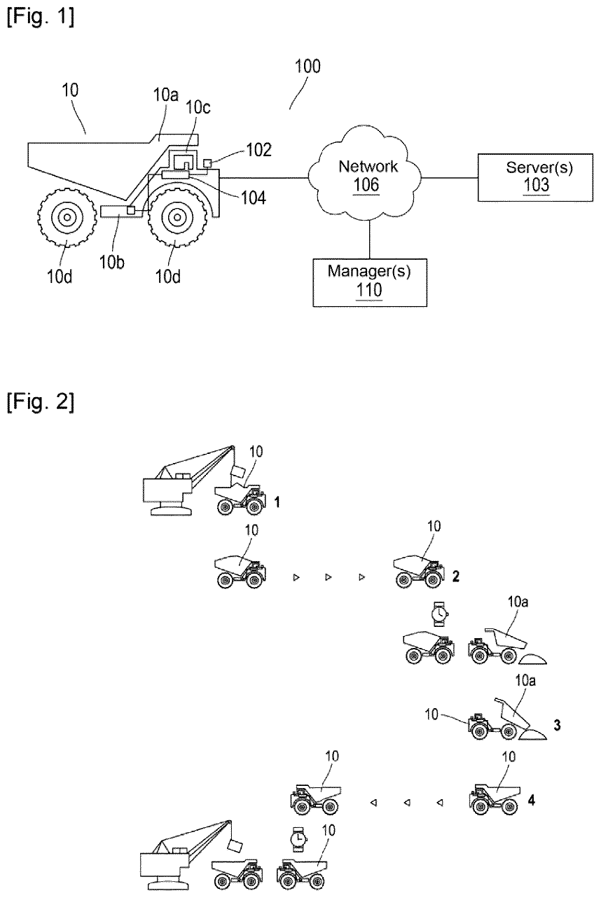

Referring now to the figures, in which the same numbers identify identical elements, the haul truck (or “truck”) 10 of FIG. 1 includes one embodiment of a system 100 of the invention incorporating at least one acoustic device that captures and records an acoustic signal associated with each phase of a mining-truck cycle. The system 100 implements a method of the invention for acoustic detection of events denoting specific phases of a mining-truck cycle.

It is understood that the haul truck 10 is given by way of example. A mining vehicle employing the system 100 of the invention could be selected from other types of vehicles (for example, forklift trucks, tractors, etc.). It is also be understood that the system 100 could be implemented with other types of vehicles not employed in the mining industry (for example, any vehicle that performs repetitive industrial or mining events and/or cycles).

Referring again to FIG. 1 and also to FIG. 2, FIG. 2 shows an example of a set of phases of a mining cycle having the associated acoustic events that are detected and recorded by the acoustic device of the system 100. During the mining cycle, a certain number of usage indicators (or analytics) may be deduced from the acoustic recording of the mining truck 10 being driven (as described below) and from which benefits may be derived. It is possible to deduce, from this acoustic recording, the key steps of mining-vehicle cycles, namely:
A phase (1) of loading ore into the dump body 10a while the mining truck 10 is stationary. When a loader 20 or excavator (not shown) loads the mining truck 10, a significant sound is generated. This sound is completely different from the sound heard when the mining truck is being driven (either loaded or empty) and when the mining truck is unloading material.
A phase (2) of driving the mining truck 10 loaded, generally while driving uphill towards an unloading area.
A phase (3) of unloading the ore in the unloading area with the mining truck 10 stationary.
A phase (4) of driving the mining truck 10 empty, generally while driving downhill towards a loading area.
At the end of the cycle, a phase of waiting for loading with the mining truck 10 stationary (which also starts the following cycle).

Each acoustic phase (or “scene”) itself has a number of specific acoustic events, arranged in a certain chronological order. In a mining cycle, there are at least five events, namely:
frequency of the engine speed of the mining truck;
breaking fan;
reversing sound (or “beep”);
sound of the front horn; and
resonance of the dump body under the effect of the impact of falling ore (for example, during phase 3 described hereinabove).

Each acoustic event is characterized by a harmonic or non-harmonic signal, a frequency range, a sound level and a specific duration. Once recorded, these events may then be detected automatically by processing the signal particular to each type of event. Processing the signals in respect of the amplitude and frequency of the recordings makes it possible to identify and detect periods in which the mining truck 10 is executing the various phases of the cycle: loading and unloading, driving loaded and empty.

Referring again to FIG. 1, in an embodiment of the system 100, the acoustic device includes at least one microphone 102 that detects and captures the acoustic events associated with each phase of the mining cycle. The microphone 102 is selected from robust, high-quality microphones available on the market from specialists, incorporating a system for acquiring acoustic signals. The microphone 102 is mounted on or in the mining truck 10 and is positioned to capture the sounds of the engine, those of the dump body 10a, the sound of the front horn and the reversing sound (or “beep”), while remaining protected from aggression and other exterior sounds. In general, the microphone 102 is positioned in front of a cab 10c of the mining truck 10 where the driver sits (as shown in FIG. 1). In one embodiment of the system 100, the microphone 102 is positioned behind the cab 10c adjacent to the dump body 10a.

The acoustic device of the system 100 also includes an acoustic recording device 104 associated with the microphone 102 to record (either in real time or via subsequent processing) the acoustic events (and therefore the corresponding phases) captured by the microphone 102. In one embodiment of the system 100, the acoustic recording device 104 includes one or more commercially available acoustic recorders, including portable, stereo acoustic recorders (for example, of the type sold under the trademark TASCAM®). By way of example, typical characteristics of an acoustic recorder selected for use in the system 100 may include a vertical resolution of 24 bits (allowing good signal sensitivity); a sampling frequency of 48 kHz (allowing frequencies up to 20 kHz to be picked up); a maximum sound power of 125 dB SPL (allowing saturation of the signal in the very noisy acoustic environment of a mining truck to be prevented); and a battery life of about 24 hours (sufficient to record a full day of mining work). It will be understood that equivalent acoustic recorders could be used.

In an embodiment of the system 100, the acoustic recording device 104 may include a means for detecting acceleration, which could be a known accelerometer (not shown). The accelerometer may be a triaxial accelerometer capable of measuring acceleration in the three spatial dimensions. The accelerometer may include micro-electromechanical sensors (MEMS) that are widely available at a low price and that remain reliable in their operation. During operation, the accelerometer detects the vertical and horizontal shocks experienced by the mining truck 10 (for example, the vertical and horizontal accelerations produced when the mining truck 10 moves over surfaces sloping upwards or downwards, and over rough surfaces). The accelerometer may be mounted anywhere on or in the mining truck 10 so as to be able to detect the impact of loading and/or unloading the truck 10. For example, the accelerometer may be located under the dump body 10a or on the frame 10b of the mining truck 10. Alternatively, the accelerometer may be positioned in the cab 10c of the truck 10.

In one embodiment of the system 100, the system may include at least one known telematics system (not shown) for determining the state of use of the mining truck 10 and/or one or more tires mounted on the mining truck. The telematics system may be employed together with the acoustic recorder 104, to allow operational data of the mining truck 10 to be monitored and recorded. These recorded data determine how and/or where the mining truck 10 may be used in a mining site. This telematics information of the mining truck 10 may include, without limitation, the following data elements:
information on the engine speed of the mining truck 10 (for example, the transmission setting such as park, drive, speed, neutral; coolant temperature; intake air temperature; barometric pressure; truck speed);
information delivered by electrical sensors (for example, visual/audio systems, brake lights, turn signals, headlights, hazard warning lights, reversing lights, reversing sounds, parking lights, windscreen wipers, doors locked, dump body actuated, battery voltage, fuel level, mileage, occupant weight, load weight);
information on the state of the mining truck (for example, its speed, its location, distance travelled (including trips made by the mining truck 10 and historical trips to a manager of the mining truck 10), the relative distance of the mining truck with respect to other trucks and/or other objects);
information regarding times and/or dates of departure and/or arrival of the mining truck 10 from/at a predetermined location (for example, a loading/unloading area);
computed information (for example, the acceleration and/or deceleration of the mining truck 10, its lateral acceleration, the pressure loss of its tires); and
identification of the driver (for example, via voice recognition, code, biometrics, retina, etc.).

The data may be collected from a variety of sources including, without limitation, mobile applications, sensors installed on the mining truck 10, vehicle interface modules (VIMs), vehicle monitoring systems (VMSs) and/or combinations and equivalents thereof. In embodiments of the system 100 allowing remote recording, the system 100 includes a communication network (or “network”) 106 that manages the data fed to the system 100 from various sources (for example, from a telematics system). The communication network 106 incorporates at least one communication server (or “server”) 108 with at least one processor that manages the data corresponding to an identified mining truck. The identified mining truck may have one or more tires 10d (see FIG. 1) incorporating one or more known sensors for generating or capturing data, such as data corresponding to an operational environment of the identified mining truck. The sensors may include a set of sensors for delivering data regarding operating characteristics of one or more identified tires. The sensors may include, for example, one or more speed sensors, one or more acceleration sensors, one or more sensors related to traction, one or more sensors related to braking, and/or a combination of sensors for collecting data regarding one or more aspects of the dynamic situation of an identified tire. The sensors may also deliver stored data regarding the identification of an identified tire (including, without limitation, its provenance as regards production, distribution and/or storage, its date of production, its retreading history if applicable, and its position and installation history).

The server may be associated with one or more mining-truck managers 110, including, without limitation, one or more fleet companies to which the one or more mining trucks belong and/or one or more mining companies. Corresponding data may be generated and/or managed, at least partly, by one or more sites served by one or more mining trucks (or by one or more networks of sites, including a specific site).

In one embodiment of the system 100, the system may include a locating means mounted on or in the mining truck 10. The locating means may detect the position of the mining truck 10 via various techniques that are known in the art, including by means of a global positioning system (GPS), an inertial navigation system and/or other equivalent locating means. The data obtained by the locating means include data corresponding to each trip made by the mining truck 10 (for example, a trip made between the loading area and the unloading area). It will be understood that a trip could include a one-way trip or one or more round trips. The data obtained by the locating means may be transmitted by the network 106 to the server 108 in order to consolidate and process these data.

A method of the invention performed by this embodiment of the system 100 may include a step of identifying expected locations of the mining truck 10 (for example, the loading and unloading areas). The identification step includes identifying coordinates of each expected location (of the areas specifically), using obtained and recorded historical GPS data (for example, recorded in one or more databases). It will be understood that the GPS recordings may be combined with acoustic scenes recorded by the acoustic recording device 104 to determine one or more specific positions of the mining truck (for example, the coordinates of the dump and unloading points, of other key places in the operation of the mining truck 10). It is also understood that images (for example, satellite images and/or images obtained by one or more cameras mounted on or in the mining truck 10) could be used to verify the coordinates of the specific positions. In all embodiments of the system 100, the obtained data could come from a vast set of mining trucks in normal operation with various operators and/or managers. The system 100 includes at least one processor that is operationally connected to a memory configured to store an application for analyzing data representative of acoustic scenes executed by the mining truck 10. The term “processor” (or, alternatively, the term “programmable logic circuit”) designates one or more devices capable of processing and analyzing data and including one or more software packages for carrying out the processing thereof (for example, one or more integrated circuits known to those skilled in the art as being included in a computer, one or more controllers, one or more microcontrollers, one or more microcomputers, one or more programmable logic controllers (or “PLCs”), one or more application-specific integrated circuits, one or more neural networks, and/or one or more other known equivalent programmable circuits). The processor includes one or more software packages for processing data captured by sub-systems associated with the system 100 (and the corresponding data obtained) and one or more software packages for identifying and locating variances and for identifying their sources in order to correct them.

In the system 100, the memory may include both volatile and non-volatile memory devices. The non-volatile memory may include solid-state memories, such as a NAND flash memory, magnetic and optical storage media, or any other suitable data storage device that retains the data when the system 100 is deactivated or loses its power supply. The volatile memory may include a static and dynamic RAM that stores program instructions and data, including a learning application.

### Example 1

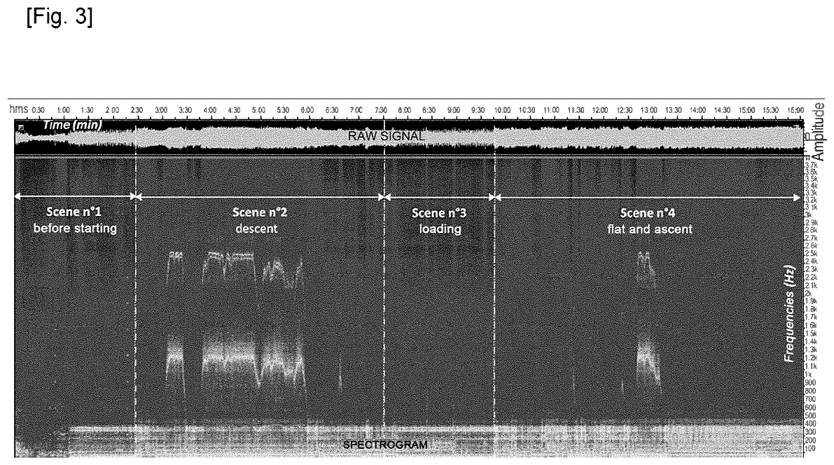

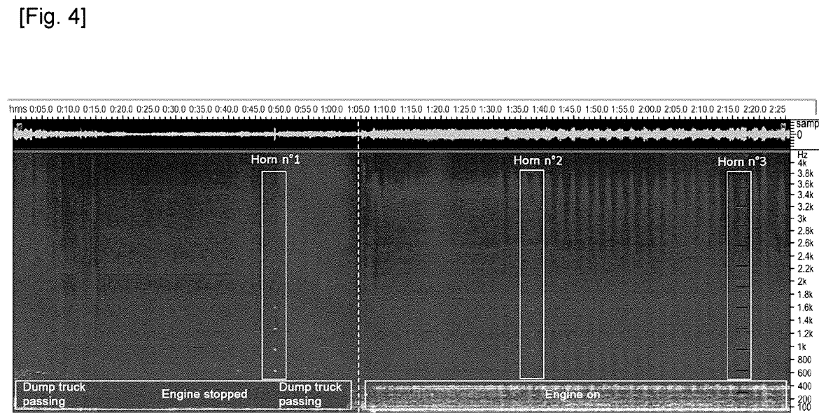

Referring again to FIGS. 1 and 2, and also to FIGS. 3 to 10, FIG. 3 shows an example of an acoustic scene defined by a time-frequency analysis (or “spectrogram”) of a 16-minute acoustic signal recorded in a copper mine. The signal was recorded with a microphone 102 positioned on the front face of the mining truck 10. There are clearly five (5) different acoustic scenes corresponding to the following phases of a mining cycle:
Scene no. 1: “before departure”;
Scene no. 2: “driving downhill”;
Scene no. 3: “loading the ore”;
Scene no. 4: “driving on level ground and uphill”; and
Scene no. 5: “unloading the ore”.

### Scene No. 1: “Before Departure”

Referring to FIG. 4, this figure shows a spectrogram of the mining truck 10 while it remains stationary. During a period of 2 minutes 25 seconds (2′25″) of the recording of the acoustic signal, the following acoustic events were heard:
the sound of other mining trucks passing;
horns being blown;
human voices; and/or
the engine of the mining truck 10 being started and the sound of it idling.

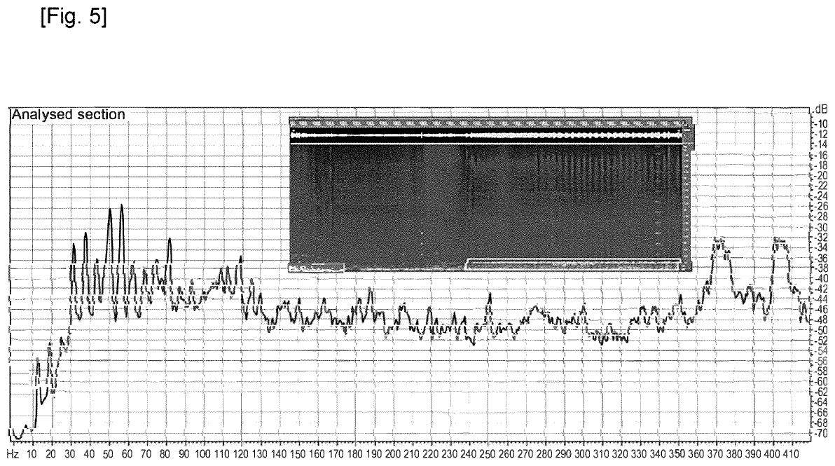

All these events have a specific acoustic signature. In particular, a low-frequency signature of the engine sound of the mining truck 10 was observed in the frequency region 0-400 Hz. Referring to FIG. 5, if the 0-400 Hz frequency spectrum of this idling turned-on engine is examined, a typical line spectrum of a harmonic signal having the following characteristics is observed:
fundamental frequency F0=7 Hz (engine idling);
number of harmonics: ˜15;
frequency range: 0 to 100 Hz; and
sound level: +25 dB above the average sound level.

From the frequency spacing of the line spectrum, engine speed may be deduced.

The blown horns also have a harmonic signature, but at a higher frequency.

### Scene No. 2: “During the Descent”

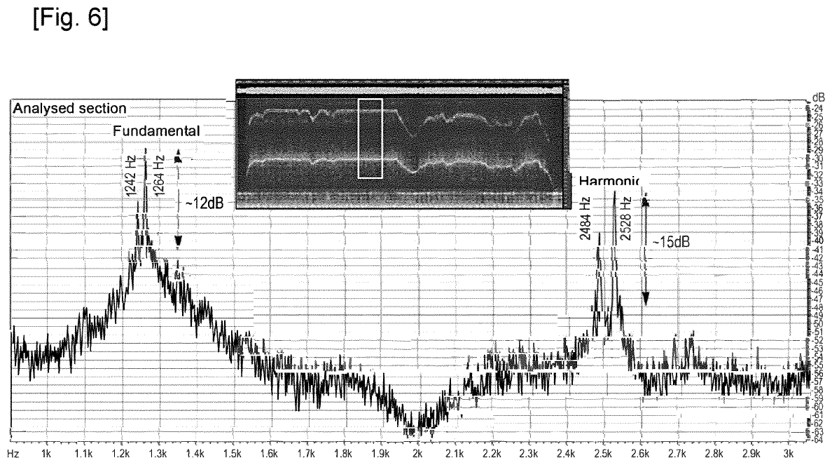

Referring to FIG. 6, which shows the spectrum of the engine brake sound, the most significant sound during the descent was a constant high-pitched sound throughout the descent. This sound was evidently generated by the fan of the automatic break (or “engine brake”) provided in mining dump trucks, which maintains a constant speed of travel at low engine speeds. This sound of the engine brake is characterized by the following characteristics:
a fundamental frequency around 1250 Hz, of an amplitude of about 12 dB; and
a single harmonic around 2500 Hz, of an amplitude of 15 dB.

It may be seen that this frequency varied in the course of a descent period of 2 minutes 07 seconds (very probably because the slope of the road was not constant and braking adjusted so as to keep the speed of the mining truck constant whatever the slope). Specifically, it may also be seen that the low-frequency sound of the engine, and therefore its speed, remained constant throughout the descent.

### Scene No. 3: “Loading the Ore”

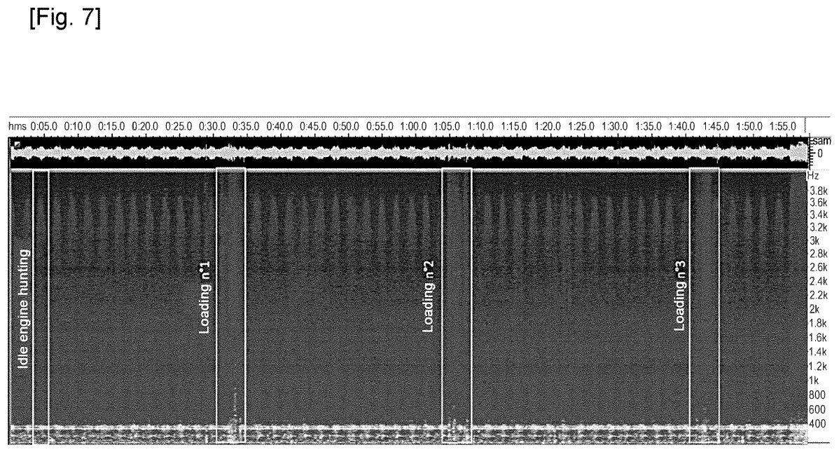

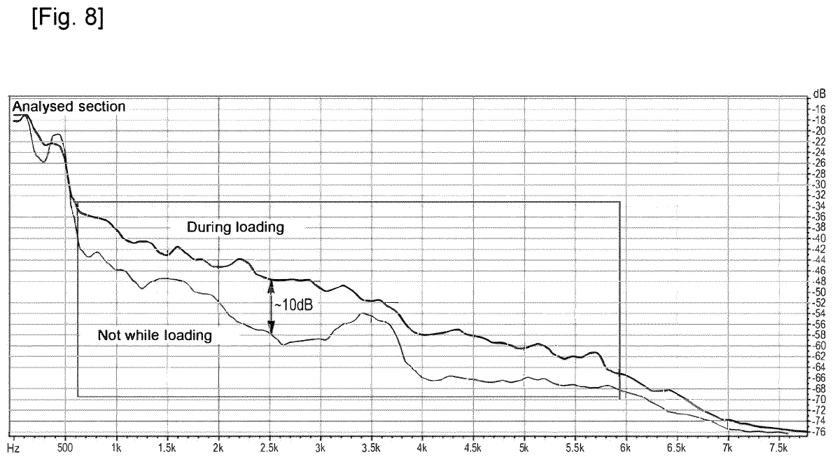

The acoustic events detected during ore loading were of two types:
the loud continuous low-frequency sound of the engine idling, associated with regular (period˜2 s) wide-band hunting, the mining truck 10 being stationary (see FIG. 7 that shows the corresponding general spectrogram); and
a short (<5 s) and very wide-band (600-6,000 Hz) ore-loading sound, of a sound level of 10 dB above the level without loading and that repeated three (3) times about every 35 s (see FIG. 8 that shows the spectrum corresponding to the sound during a loading phase). In this example, the total duration of the loading period is 1 minute 55 seconds.

### Scene No. 4: “Driving Uphill”

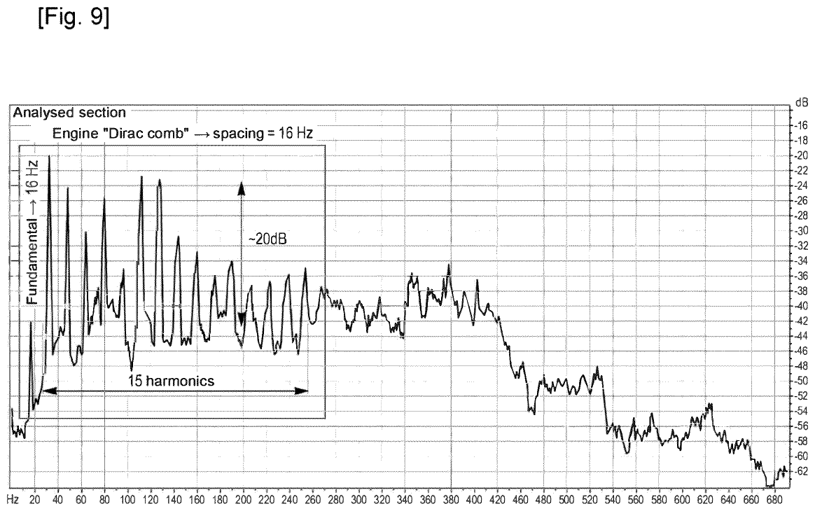

Referring to FIG. 9, which shows a line spectrum of the engine sound during a phase of driving uphill, the most striking acoustic event was once again the sound of the engine (characterized by its low-frequency line spectrum, the fundamental frequency of which is dependent on engine speed and therefore on speed of travel). During this phase, the mean line spectrum of the sound of the engine had a spacing of 16 Hz, therefore corresponding to the maximum engine speed. In passing, it will be noted that the high-frequency sound, detected on descent and attributed to the engine brake, was no longer observed.

### Scene No. 5: “Unloading the Ore”

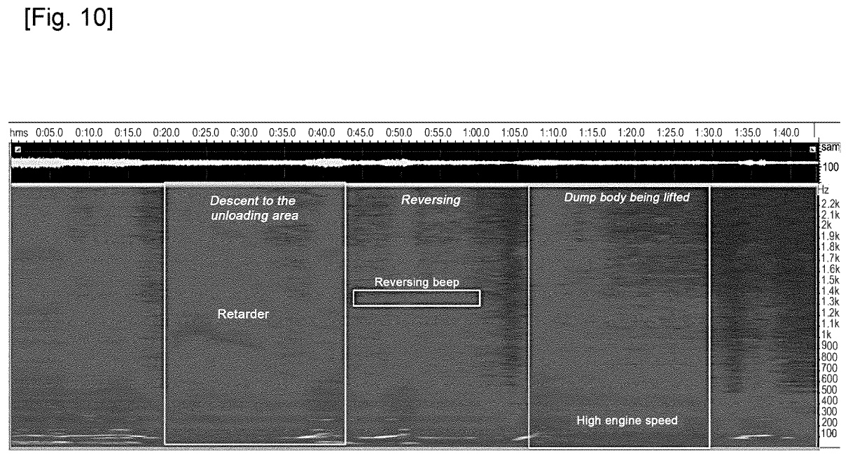

By analyzing the periodicity of the cycles, the acoustic unloading scene was discovered after the ascent phase, this scene being characterized by a high engine speed (see FIG. 10, which shows a spectrogram of the sound of unloading). This phase began with a reversing sound (or “beep”) followed by no blown horn, either at the start or end of unloading. The sound of the ore sliding from the emptying dump body 10a was at the limit of audibility (very probably because of the position of the microphone 10a). In contrast, engine speed was clearly audible, as it increased to deliver the high power required to lift the dump body 10a. Lastly, it appears that the unloading area was in a slight dip because, before the reversing beep, the sound of the break was detected for about 10 s.

Thus, the various phases of a mining cycle are characterized by acoustic events that are very distinct, and which may be classified into five (5) types (see Table 1 below).

TABLE 1

| | properties | | | | | | |
|---|---|---|---|---|---|---|---|
| | | Fundamental | | | | | |
| | Type of | frequency | Number | Frequency | | Sound | |
| event | sound | F0 | of harmonics | range | | level | Duration |
| Engine | harmonic | 5-20 Hz | ~15 | <200 | Hz | increases | variable |
| | | increases | | | | with | |
| | | with engine | | | | engine | |
| | | speed | | | | speed | |
| Retarder | harmonic | 800-1300 Hz | 2 | 800-3000 | Hz | increases | variable, ~minutes |
| | | increases | | | | with | |
| | | with braking | | | | braking | |
| | | level | | | | level | |
| Reversing beep | Alternating | 1340 Hz | 0 | 1320-1360 | Hz | High | ~20 s |
| | single | | | | | | |
| | frequency | | | | | | |
| Front horn | harmonic | Around 160 | 20 | >400 | Hz | High | ~2 s |
| | | Hz (depending | | | | | |
| | | on the type | | | | | |
| | | of dump truck) | | | | | |
| Dump body | “white” noise | NA | NA | <20 | Hz | Medium | ~2 s |

It will be understood that this number of acoustic events is non-limiting.

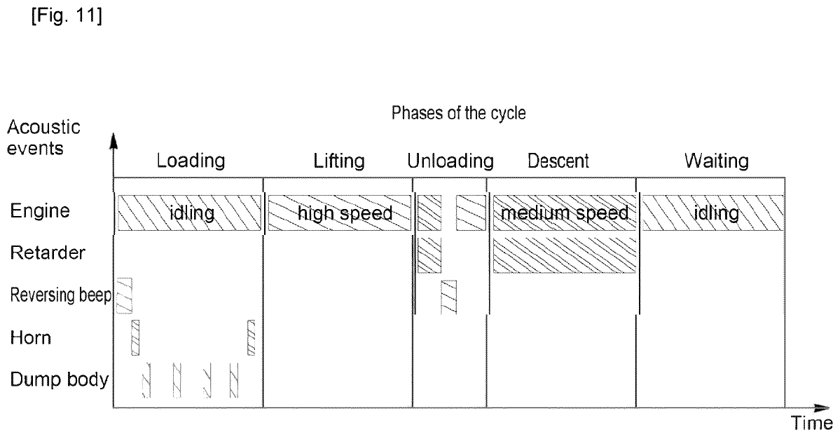

Referring to Table 1 above, and referring further to FIG. 11, which shows acoustic phases of a mining cycle (and the corresponding engine speed), loading areas may be identified almost systematically by an acoustic scene having the following successive acoustic events:
reversing sound (or “beep”);
engine idling;
front horn to signal the start of the phase of loading/unloading ore;
sound of “resonance” of the dump body (initiated by ore falling into the dump body, several times, there being one minute on average between each loading/unloading operation); and
front horn to signal the end of loading/unloading.

These loading areas are generally preceded by a waiting phase, with the mining truck 10 stationary and the engine idling. The unloading areas for their part differ in a reversing beep; a maximum engine speed as the dump body 10a rises; and/or the absence of horn blowing.

It is understood that a time-frequency analysis represented by a spectrogram is an effective means of detecting the various acoustic events. However, as soon as the duration of the recordings becomes too long, or the number of mining trucks to be tracked too large, it is preferable to envisage automatic detection, or even real-time detection, of the phases of the mining cycles. It begins with detection of the various acoustic events mentioned.

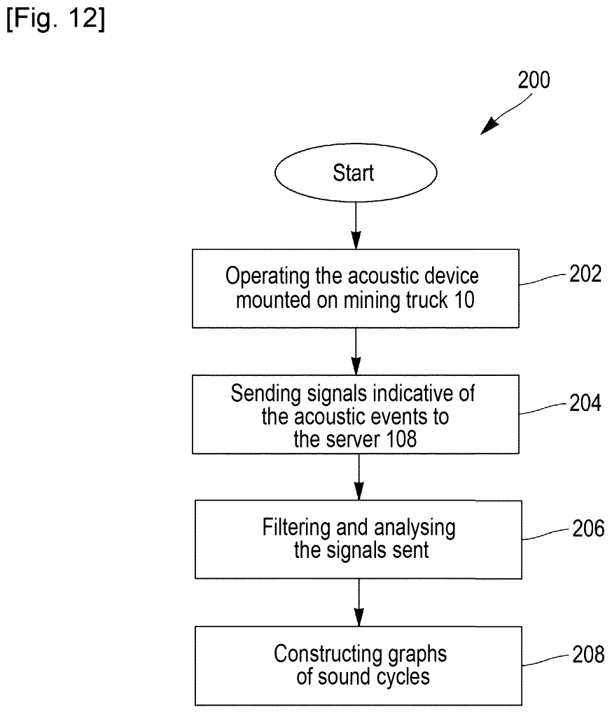

Referring again to FIGS. 1 to 11, and referring further to FIG. 12, FIG. 12 shows a flowchart of an embodiment of a method 200 of the invention. The method 200, implemented by the system 100, allows acoustic detection of events denoting specific phases of a mining-truck cycle. The method 200 is implemented by computer (for example, by the processor of the server 108) so that the system 100 may identify the current phase of a mining cycle in progress based on the acoustic events detected by the system.

As used herein, the term “method” or “process” may include one or more steps performed by at least one computing system including one or more processors for executing instructions that perform the steps. Any sequence of steps may be given by way of example, and the described methods are not limited to any particular sequence.

Upon starting the method 100, the method includes a step 202 of operating the system 100, and particularly of operating the acoustic device of the system 100, which is mounted on or in the mining truck 10. The acoustic device is able to capture the acoustic event in real time and generate one or more signals indicative of this acoustic event.

In a next step 204, the acoustic device sends the one or more captured signals to the server 108, either in real time (for example, via the network 106) or after subsequent processing. The corresponding data are recorded (for example, in a database of the system 100), and they are updated as the method progresses (either on a continuous basis or on an intermittent basis).

A processor of the server receiving the one or more signals indicative of one or more acoustic events may filter and analyze these signals to determine the presence and/or absence of particular sounds and/or their frequency and duration. In a step 206 of the method 200, the processor uses this information to filter and to analyze the sent signals.

The method includes a last step 208 of constructing one or more graphs of sound cycles representing the temporal correlations between the various events (and therefore the transitions of the various phases of the mining cycle). During this step 208, the processor may compare the constructed graph with one or more predefined graphs, each of which is indicative of a particular acoustic event and the phases with which they are associated. For example, as shown in FIG. 2, the predefined phases may include the loading phase (1), the phase (2) of driving loaded, the unloading phase (3), the phase (4) of driving empty and the one or more phases of waiting with the mining truck 10 stationary.

The method (200) further includes a step of processing an acoustic signal. During this step, the listed acoustic events may be classified into two types of sound:
wide-band “white” noise: engine sound, break sound, ore sound; and
harmonic noise: engine speed, reversing beep and horn, resonance of the dump body.

To each of these two types of sound there corresponds two families of methods for processing the acoustic signal. In the method applied in the case of wide-band “while” noise, the signal is in general filtered in the corresponding frequency band, this possibly being followed by decimation in order to limit computational load. The root-mean-square (RMS) sound level of the filtered signal is then computed and compared with a predetermined threshold. In this method, “level” detection is spoken of.

In another embodiment of this method (the “spectral RMS” method), the frequency spectrum is computed in a sliding window of the time-domain signal, and the acoustic power is deduced therefrom via integration in the desired frequency band. This is moreover how the spectrograms shown in and described above with respect to FIGS. 3, 4, 7 and 10 by way of example, are computed.

In the method applied in the case of harmonic noise. the raw signal is filtered and optionally decimated. Next, it is sought to detect the harmonics of the resulting signal via specific methods (for example, of the comb-filtering, cepstral-analysis, spectral-autocorrelation or synchronous-averaging type, and/or methods inspired by those used in the detection of faults in rotary machines). In this method, “frequency” detection is referenced.

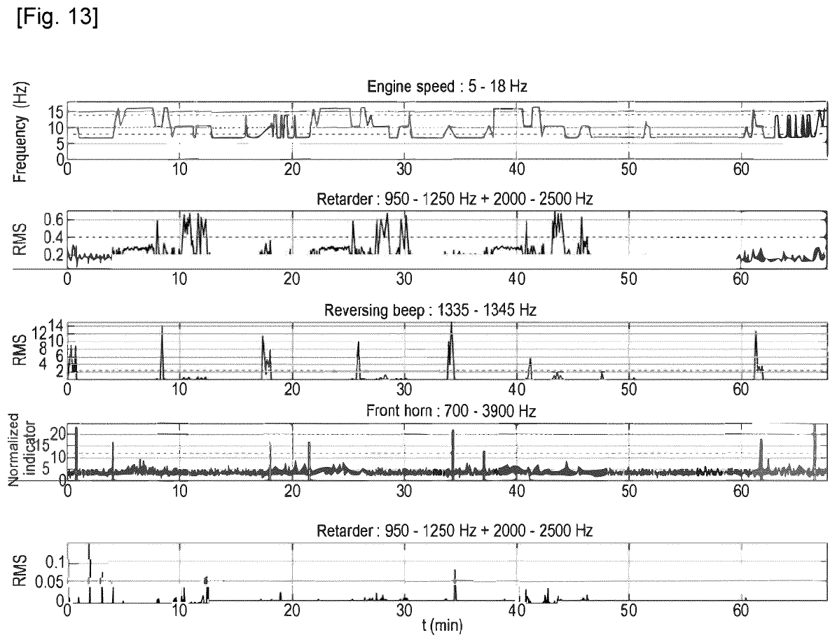

In the method 200 of the invention, once the various acoustic events have been detected during step 202, it is possible to deduce therefrom the various phases of the mining cycle during a step 208. During this step, the arrangement and consistency over time of these detected acoustic events are studied (as schematically shown in FIG. 13). It may therefore be said that an acoustic scene is a chronological “sequence” of acoustic events. By way of example, if the front horn is detected to have been blown twice in a period of less than 5 minutes, with therebetween a number of sounds of resonance of the dump body 10a, it is very likely that the mining truck 10 is in a phase of loading ore. The robustness of detection may also be increased by verifying that the engine is idling between the two times the horn is blown and/or that the reversing beep is present just before the first time the horn is blown. For the driving phases, it is first verified that the engine of the mining truck 10 is not stopped or idling. The sound level of the engine must be above an adequate threshold and/or its fundamental frequency must be above 7 Hz. It is then possible to seek to detect downhill phases via the sound of the break, and phases of maximum engine speed, which may be associated with phases of driving uphill. The loading phase is here characterized by the following sequence of events: slight descent; reversing beep; and high engine speed (corresponding to the dump body 10a being lifted). Lastly, it is presumed that the standard chronological sequence of a mining cycle is always driving/loading/driving/unloading.

### Example 2

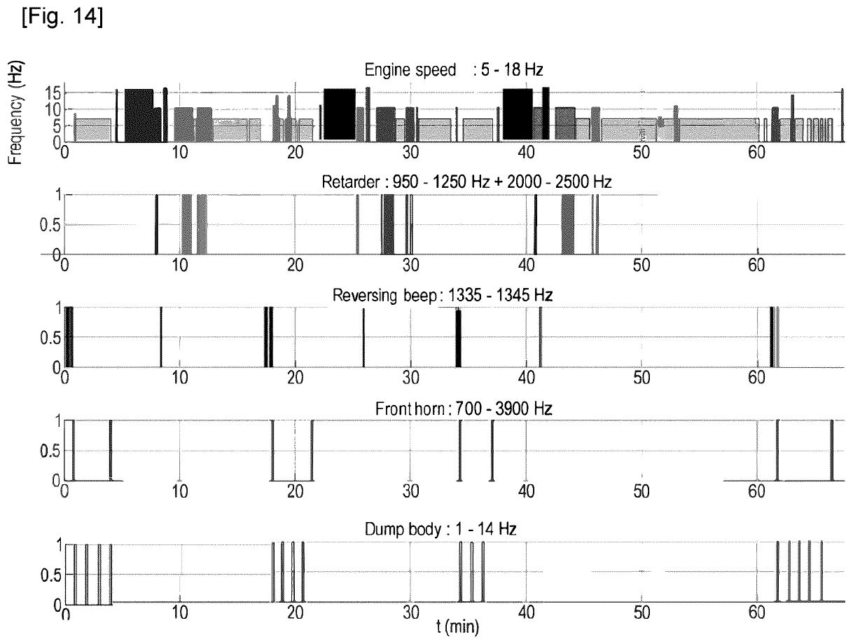

An algorithm for automatically detecting the aforementioned acoustic events has been employed on the recording of 10 hours of operation of the mining truck 10 in an iron mine. Referring to FIGS. 13 and 14, these figures show, over a period of slightly more than one hour of recording, the variation in the sounds of the engine speed, of the break, of the reversing beep, of the front horn and of the dump body 10a.

Referring to the curves of FIG. 13, this figure shows how the various acoustic events are extracted, based on thresholds for RMS levels or other average indicators of the signal.

### Engine Speed:

Description: representation of the variation as a function of time in the fundamental acoustic frequency F0 (in Hz) of the engine, a multiple of which is the engine speed. The relatively darkly shaded, horizontal segments represent the average value over each sequence, which is assumed to remain stable.
Method: The raw signal was first decimated at a sampling frequency F0 of 1000 Hz. Next, for each sliding time window of 5 s, a specific “spectral autocorrelation” algorithm rapidly searched for a first value of F0 between 5 and 18 Hz. Lastly, another specific “synchronous averaging” algorithm allows the F0 value to be refined.
Classification: Two frequency thresholds to which the data were compared have been shown by dotted lines: 8 Hz and 14 Hz. Below 8 Hz, the engine is considered to be at low speed or even idle (the average color of the segments is light grey). Above 14 Hz, the engine is at maximum speed (the color of the segments is black). Between the two extremes, the engine is at an intermediate speed (the color of the segments is dark grey).

### Break:

Description: representation of the variation as a function of time in the RMS acoustic level of the sound of the break fan (which only triggers when going downhill). The horizontal black segments correspond to the relevant “stable” areas (above the threshold).
Method: The sound of the fan is specifically expressed by two harmonics, the first being at around 950-1250 Hz and the second at around 2000-2500 Hz. Methods for detecting harmonics prove not to be very effective, probably because the signal changes too fast. The signals therefore simply underwent two band-pass filtering operations, in each of the harmonic areas. Next, an average RMS acoustic level was evaluated in each of the bands via the envelope method, in a sliding window of 2 s. The two RMS levels were then summed and then normalized by the overall RMS level of the complete signal. The final RMS was then compared to the threshold of 0.4, which has been shown by a dotted line. This threshold, where the sound level of the break represented 40% of the overall sound level, proved to be the most relevant for isolating the sound of the retarder with robustness.

### Reversing Beep:

Description: representation of the variation as a function of time in the RMS acoustic level of the sound of the reversing beep (which was triggered automatically when the mining truck 10 reversed). The horizontal black segments correspond to the relevant “stable” areas (above the threshold).
Method: The sound of the reversing beep was mono-frequency around 1335-1345 Hz. The simplest way of proceeding was to compute the spectrum in a sliding time window of 5 s, and to compute a frequency-domain RMS in the band 1335-1345 Hz. Normalization by the overall RMS proved not to be necessary but could be envisaged to increase robustness. This RMS was then compared with a threshold of 2.5×10⁻⁷, shown by the dotted line. This threshold proved to be the most relevant for isolating the sound of the reversing beep.

### Front Horn:

Description: representation of the variation as a function of time in the normalized indicator of the sound of the horn (see the method described below) and the corresponding threshold.
Method: The horn signal, just like that of the engine, was harmonic but in a much higher frequency band (>700 Hz). The spectral-autocorrelation method in a sliding time window of 0.5 s proved to be the most effective. A normalized indicator (normalized with respect to the spectral autocorrelation of a white-noise signal) was then compared with a relevant threshold (here 12).

### Dump Body:

Description: representation of the variation as a function of time in the RMS level of the very low frequency sound of impact of the ore when it was loaded into the dump body.
Method: This dump-body sound is emitted over a very wide spectral band. However, its very low frequency part (<14 Hz) proved to be better for discrimination purposes. The “spectral RMS” method used to detect the reversing beep proved to be equally effective for this dump-body sound. The threshold of 104 (shown by the dotted line) proved to be the most relevant. However, certain engine acceleration or resonance sounds may sometimes also appear at very low frequencies. In order to ignore these, the dump-body sound was only evaluated during loading periods (i.e., between the two blows of the horn).

Reference will now be made to FIG. 14, which should clarify the preceding technical analysis. FIG. 14 shows the same thing as FIG. 13, but it only shows the retained acoustic events, schematically, so as to allow the chronological sequence of the various events to be identified more simply. The thresholds and continuous time-dependent curves have been removed, only relevant events (i.e., ones above thresholds, except in the case of the sound of the engine) having been kept, expressed without units. This allows the interpretation to be simplified by facilitating temporal correlations between the various events.

A certain number of recurrences are discernible in this hour of recording:
If the horn sound is analyzed first, four (4) successive pairs thereof were detected. The duration of a pair was of the order of 4 min, and the period between each pair was 20 min on average.
Between each pair of horn blows, 3 to 4 short dump-body sounds were detected.
Lastly, if “reversing beep” events are analyzed, it is noted that, just before the start of each pair of horn blows, a relatively long reversing beep (˜20 s) is present.

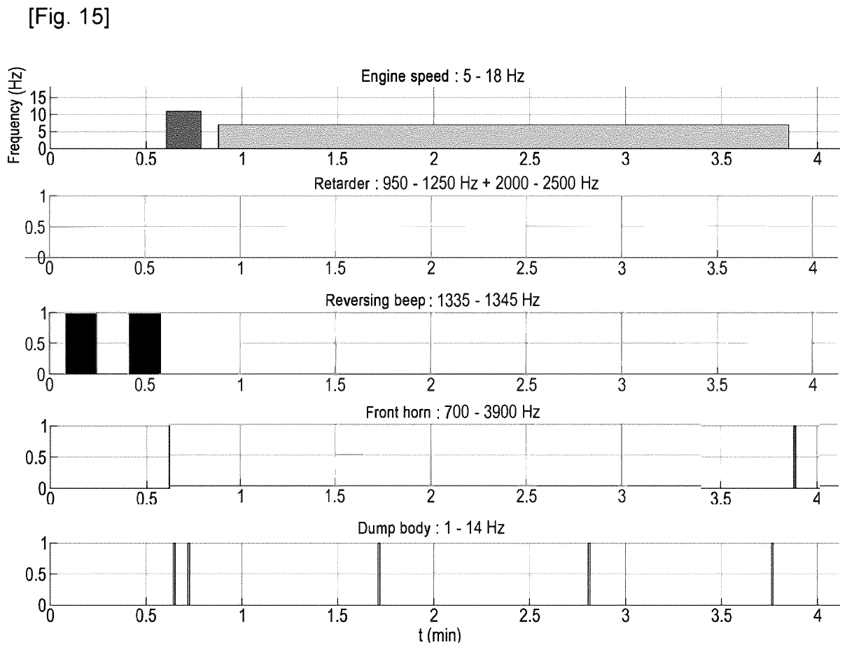

Referring to FIG. 15, it is evident that this chronological sequence (reversing beep/horn 1/dump body/horn 2) includes the typical acoustic “scene” (or “signature”) of loading. It will also be noted that, during loading, the engine was generally idling (˜7 Hz).

In this iron mine, the loading phase therefore involved the following steps:
1. The mining truck 10 reversing towards a loader 20 (“reversing beep”) for about 20 s.
2. Horn blown to alert the loader 20 that the mining truck 10 was in place, stationary.
3. First loading operation followed by other loading operations spaced apart by about 1 min (representing the time the loader 20 took to “reload”).
4. Horn blown to indicate that the mining truck 10 was ready to leave the loading area.

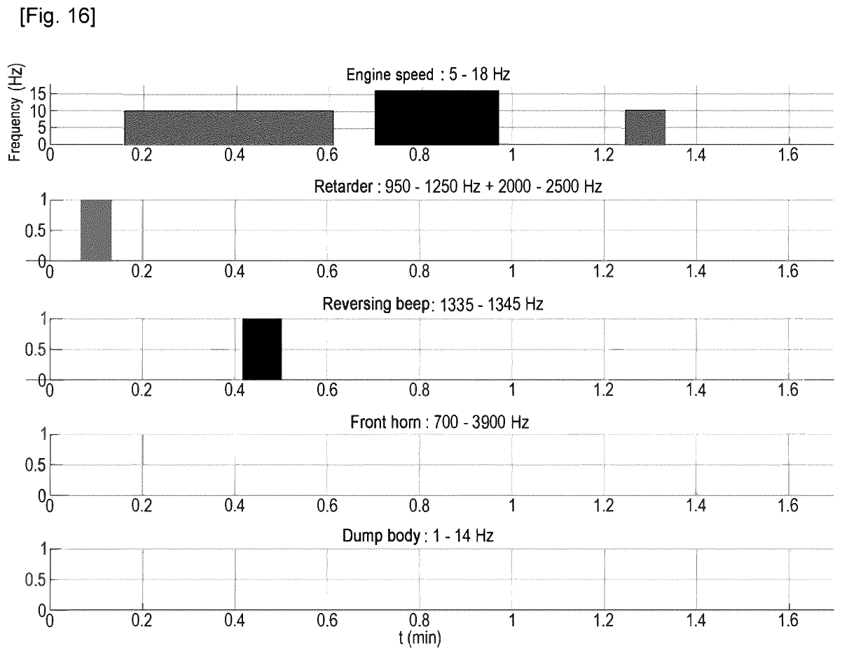

Referring to FIG. 16, by analyzing the acoustic scene, it may be seen that the unloading phase for its part involved the following steps:
1. Moving downhill (“break”) for about 10 seconds towards the unloading area.
2. Reversing the mining truck (“reversing beep”) for about 10 seconds to get into position.
3. Lifting the dump body 10a (“high engine speed”) for 20 s (representing the unloading time).

Lastly, by analyzing the sound of the engine speed and of the break together, three (3) very clear engine-speed phases may indeed be observed. After the end of loading (final blow of the horn), each phase was marked by the following steps:
1. First, by an increase in engine speed to its maximum for about three (3) minutes, this corresponding to the phase of ascent from the bottom of the mine.
2. Next, the engine passed to an intermediate speed, at the same time as the break started. The mining truck 10 was descending to the unloading area.
3. The unloading phase seen above then began.
4. After this phase, the mining truck 10 began its descent back to the mine, this being characterized by the sound of the break and an intermediate engine speed (the descent lasted a little more than 2 minutes).
5. The mining truck 10 then arrived at the loading area, where it had to wait for its turn to load (this wait being denoted by the engine idling for several minutes).

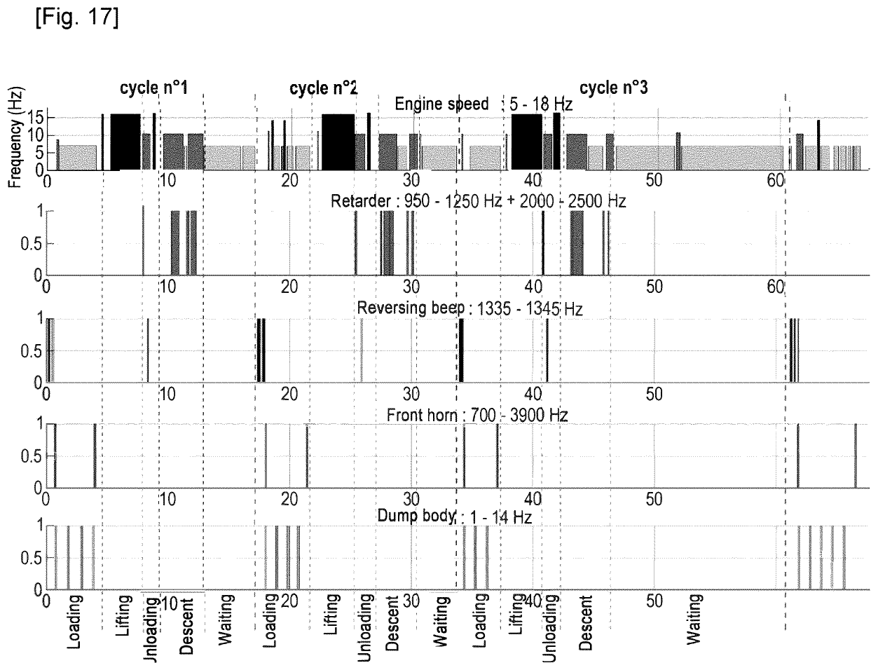

This interpretation of the chronology of the acoustic events is represented in FIG. 17.

Every load transported by a mining vehicle may be of great value, requiring processes within a mine to be efficient. Acoustics is a means that is easy to implement, accessible, inexpensive, and evidently novel in the mining field, allowing knowledge of how a mining vehicle is being used to be gathered independently of cycle data (which normally belong to the manufacturers of mining vehicles). Thus, the disclosed invention allows a typical mining cycle to be identified by detecting and arranging chronologically particular acoustic events into acoustic scenes corresponding to the various phases of the mining cycle.

Information regarding the expected events may be pre-programmed into the system 100 of the invention. For example, parameterization of the method 200 may be associated with parameters of typical physical environments (for example, mines) in which the system 100 operates.

In embodiments of the invention, the system 100 (or another system incorporating the system 100) may receive audio commands (including voice commands) or other audio data (for example, representing a request to perform one or more steps of the method 200). The request may include a request for the current state of a mining cycle in progress. A generated response may be rendered audibly, visually, in a tactile manner (for example, using a haptic interface) and/or in a virtual and/or augmented manner. This response, together with the corresponding data, may be recorded in a neural network.

It will be understood that the system 100 may include a plurality of computing devices that perform various aspects of the learning. In these embodiments, the processor may configure the system 100 to one or more parameters of an acoustic scene and its known events. In these embodiments, it will be understood that one or more reinforcement-learning means could be used.

In all embodiments of the system 100, a monitoring system could be installed. At least part of the monitoring or “alerting” system may be provided in a portable device, such as a mobile network device (for example, a mobile telephone, a laptop computer, one or more portable devices connected to the network (including “augmented reality” and/or “virtual reality” devices, wearable clothing connected to the network and/or any combinations and/or any equivalents thereof)). It is conceivable for the detecting and comparing steps to be able to be performed iteratively.

The terms “at least one” and “one or more” have been used interchangeably. The ranges that have been presented as lying “between a and b” include the values “a” and “b”.

Although particular embodiments of the disclosed apparatus have been illustrated and described, it will be understood that various changes, additions and modifications may be made without departing from either the spirit or the scope of the present disclosure. Therefore, no limitations should be placed on the scope of the described invention, apart from those disclosed in the appended claims.

1.-15. (canceled)

16. A system installed in a mining truck that includes a dump body pivotally mounted on a frame, a cab where an operator of the mining truck sits, and an engine associated with the frame, the system implementing a method for detecting acoustic events denoting phases of a cycle of the mining truck, and the system comprising:
at least one acoustic device that captures an acoustic event associated with a phase of a cycle of the mining truck and that generates one or more signals indicative of the captured acoustic event, each phase consisting of a number of specific acoustic events arranged in a predetermined chronological order, the acoustic device comprising:
at least one microphone that detects and captures the acoustic events associated with each phase of the mining cycle, the at least one microphone being mounted on or in the mining truck; and
an acoustic recording device associated with the at least one microphone that records the acoustic events captured by the at least one microphone;
at least one memory configured to store an application for analyzing the signals generated by the acoustic device and representative of the phases executed by the mining truck with which the captured acoustic events are associated;
one or more communication servers each comprising at least one or more processors operationally connected to the memory, the one or more processors comprising a module for executing the analyzing application, which processes the signals indicative of the acoustic events to determine a presence and/or absence of particular sounds and/or a frequency and duration of the particular sounds, the one or more processors being capable of executing programmed instructions stored in memory to carry out the following steps:
a step of operating the system, during which step the acoustic device captures one or more acoustic events in real time and generates one or more signals indicative of each captured acoustic event;
a step of sending the one or more signals to the one or more communication servers, which step is performed by the acoustic device;
a step of filtering and analyzing the sent signals, which step is performed by the at least one or more processors of the one or more communication servers receiving the signals; and
a step of constructing a graph of sound cycles representing temporal correlations between the analyzed acoustic events and an expected chronological order of one or more associated phases, during which step the at least one or more processors compares the constructed graph with one or more predefined graphs, each being indicative of the arranged and specific acoustic events and the phases with which the arranged and specific acoustic events are associated,
wherein each acoustic event is characterized by an acoustic signature allowing periods of loading and of unloading and periods of driving loaded and empty to be identified from amplitude and frequency of the recordings.

17. The system according to claim 16, wherein the phases of the mining cycle incorporating the associated acoustic events that are detected and recorded comprise:
a phase of loading ore into the dump body while the mining truck is stationary in a loading area;
a phase of driving the mining truck loaded;
a phase of unloading the ore with the mining truck stationary in an unloading area;
a phase of driving the mining truck empty; and
at the end of the cycle, a phase of waiting for loading with the mining truck stationary.

18. The system according to claim 16, wherein the acoustic signature of each acoustic event is classified into two types of sounds comprising:
a white noise associated with at least one sound among an engine sound, a break sound and/or an ore sound; and
a harmonic noise associated with at least one sound among an engine speed, a horn, a reversing sound and a resonance of the dump body.

19. The system according to claim 16, wherein the acoustic recording device comprises acceleration-detecting means mounted on or in the mining truck so as to be able to detect a shock of loading and/or unloading the truck.

20. The system according to claim 16, further comprising at least one telematics system that monitors and records operational data of the mining truck.

21. The system according to claim 16, further comprising locating means mounted on or in the mining truck selected from a global positioning system and an inertial navigation system.

22. The system according to claim 16, further comprising a communication network that manages data fed to the system, the communication network incorporating at least one communication server with at least one processor that manages data corresponding to an identified mining truck.

23. The system according to claim 22, wherein the at least one communication server is associated with one or more mining-truck managers, including one or more mining companies to which the mining truck belongs.

24. A method for detecting acoustic events related to phases of a cycle of a mining truck, the method being implemented by a system installed in the mining truck and comprising the following steps:
a step of operating the system, during which step an acoustic device of the system captures one or more acoustic events in real time and generates one or more signals indicative of each captured acoustic event;
a step of sending the one or more signals to a server of the system, which step is performed by the acoustic device;
a step of filtering and analyzing the sent signals to determine a presence and/or absence of particular sounds and/or a frequency and duration of the particular sounds, this step being performed by a processor of the server receiving the signals; and
a step of constructing a graph of sound cycles representing temporal correlations between the analyzed acoustic events and an expected chronological order of one or more associated phases, during which step the processor compares the constructed graph with one or more predefined graphs, each being indicative of the arranged and specific acoustic events and the phases with which the arranged and specific acoustic events are associated,
wherein each acoustic event is characterized by an acoustic signature allowing periods of loading and of unloading and periods of driving loaded and empty to be identified from the amplitude and frequency of the recordings.

25. The method according to claim 24, further comprising a method for processing a wideband white-noise acoustic signal associated with at least one sound among an engine sound, a break sound and/or an ore sound, this step comprising the following steps:
a step of filtering the signal in a corresponding frequency band;
a decimating step, in order to limit computational load;
a step of computing a root-mean-square sound level of the filtered signal; and
a step of comparing the computed root-mean-square sound level with a predetermined threshold.

26. The method according to claim 24, further comprising a step of processing a wideband white-noise acoustic signal associated with at least one sound among an engine sound, a break sound and/or an ore sound, this step comprising the following steps:
a step of computing a frequency spectrum in a sliding window of the time-domain signal; and
a step of deducing acoustic power via integration in a desired frequency band.

27. The method according to claim 24, further comprising a step of processing a harmonic acoustic signal associated with at least one sound among an engine speed, a horn, a reversing sound and a resonance of the dump body, this step comprising the following steps:
a step of filtering the signal in a corresponding frequency band;
a step of decimating the signal; and
a step of detecting harmonics of the resulting signal.

28. The method according to claim 27, wherein the step of detecting the harmonics of the signal is performed by way of a method selected from the group consisting of comb-filtering, cepstral-analysis, spectral-autocorrelation, and synchronous-averaging methods.

29. The method according to claim 24, further comprising a step of identifying expected locations of the mining truck, wherein the identifying step comprises identifying coordinates of each expected location using data obtained by a locating means mounted on or in the mining truck.

30. A mining truck comprising:
a dump body pivotally mounted on a frame;
a cab in which an operator of the mining truck sits;
an engine associated with the frame;
a module for executing a method allowing acoustic events denoting phases of a cycle of the mining truck to be detected, the executing module comprising an analyzing application for analyzing one or more signals indicative of the acoustic events in order to determine whether the mining truck is in a course of a mining cycle and, when an acoustic event represented by these signals is present, to determine a current phase of the mining cycle being executed by the mining truck.
